(19) United States
(12) Patent Application Publication
(10) Pub. No.: US 2025/0111203 A1
(43) Pub. Date: Apr. 3, 2025

(54) TIER-BASED FEW SHOT GENERATION

(71) Applicant: Microsoft Technology Licensing, LLC, Redmond, WA (US)

(72) Inventors: Mahan DAS, Sunnyvale, CA (US); Jeremias Lion EICHELBAUM, Seattle, WA (US); Melissa AILEM, Los Angeles, CA (US); Ye XING, Wellesley, MA (US)

(21) Appl. No.: 18/523,806

(22) Filed: Nov. 29, 2023

Related U.S. Application Data
(60) Provisional application No. 63/586,954, filed on Sep. 29, 2023.

(51) Int. Cl. G06N 3/0455; G06F 21/55; G06N 3/08

(52) U.S. Cl. CPC G06N 3/0455; G06F 21/554; G06N 3/08; G06F 2221/034

(57) ABSTRACT

A computer-implemented method is provided that generates shots for inclusion in a few-shot learning technique. The method includes generating an input, such as a prompt, for a generative model. The input includes a received example generative model input, and instructions which, when processed by the generative model, cause the generative model to generate example input instructions according to different tiers. The input is provided to the LLM, and in response the generated example input instructions are received. The generated example input instructions are stored as shots in a data store, with the computer language input.

### BACKGROUND

Security hunting or threat hunting involves proactively searching for security threats to a computer system. One challenge for security analysts is understanding the structure and format of security data, in order to be effective when performing a security investigation. Companies use numerous different security products to protect and defend their assets. Most of these security products use their own proprietary log structure, which can be difficult to understand, and requires a considerable amount of time for an analyst to become proficient in interrogating. Microsoft® security products (e.g., Microsoft® Sentinel®/Defender®) employ a query language called Kusto Query Language (KOL) for querying these logs, which is often unfamiliar for junior analysts with limited knowledge of the relevant table and schema definitions.

Recently, generative models such as Large Language Models (LLMs) employing a transformer architecture have been developed. LLMs are trained on a very large quantity of data, comprising a wide variety of diverse datasets. For example, GPT-3 (Generative Pre-trained Transformer 3) developed by Open AI® has 175 billion parameters and was trained on 499 billion tokens. LLMs receive textual input—referred to as a “prompt”—and generate text in response. The vast nature of the training data means that LLMs can be employed in a wide range of tasks, including the generation of code in computer languages (e.g., KOL queries) from natural language text input.

The performance of LLMs in carrying out such tasks is generally improved by the use of few-shot learning. In few-shot learning, the prompt provided to the LLM includes a small number of labelled examples (the “shots”), which guide the LLM to provide accurate output.

### SUMMARY

According to one aspect of the disclosure, there is provided a computer implemented method, comprising: receiving an example generative model output; generating an input for a generative model, the input comprising: the example generative model output, and instructions which, when processed by the generative model, cause the generative model to generate a first example input instruction according to a first tier and a second example input instruction according to a second tier, the first example input instruction and second example input instruction each corresponding to the example generative model output; providing the input to the generative model; receiving a response from the generative model including the first example input instruction and the second example input instruction; extracting the first example input instruction and second example input instruction from the response; and storing, in a data store, a first shot comprising the first example input instruction and the example generative model output and a second shot comprising the second example input instruction and the example generative model output.

Instructing the generative model to generate example input instructions (e.g., natural language queries) in correspondence with different tiers results in the generation of shots that more closely corresponds to the input instructions received at inference time. Consequently, the shots generated according to this technique result in improvements in responses generated at inference time, such as improved natural language to code conversion.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic block diagram of an example environment including a system according to the disclosure.

FIG. 2 is a diagram of an example shot.

FIG. 3 is a schematic flowchart of an example method of generating KQL queries.

FIG. 4 is a schematic flowchart of an example method of generating natural language from KQL queries.

FIG. 5 illustrates example natural language queries associated with different personas.

FIG. 6 illustrates an excerpt of an example persona generation prompt.

FIG. 7 is a schematic block diagram of an example system employing a shot data store generated according to the disclosure.

FIG. 8A is a table illustrating an evaluation of the performance of the techniques discussed herein.

FIG. 8B is a graph illustrating an evaluation of the performance of the techniques discussed herein.

FIG. 9 is a schematic block diagram of another example system according to the disclosure.

FIG. 10 is a schematic block diagram of another example system according to the disclosure.

FIG. 11 is a schematic block diagram of another example system according to the disclosure.

FIG. 12 is a schematic block diagram of an example system according to the disclosure.

FIG. 13 is a schematic block diagram of an example computing system.

### DETAILED DESCRIPTION

Examples of the disclosure relate to few-shot learning using a generative model such as an LLM to produce an output. At inference time, the shots included in the prompt are selected from a database of stored shots, each shot including an example input instruction to the generative model and a corresponding expected output of the generative model. In the example of query language generation, the input is a natural language query and the expected output is a corresponding query language query. The shots included in the prompt are selected based on their relevance to an inference time input instruction (e.g., a natural language query provided by a user), so that the shots are relevant examples which are useful in guiding the generative model to generate the output based on the input instruction. The efficacy of this approach is to some extent based on the similarity between the input instruction and the example input of the selected shot. For example, in the case of query language generation, the efficacy is based on the similarity in language and writing style between the natural language query of the selected shots and the natural language input query.

It may be impractical to generate a sufficiently large database of stored shots manually, so a generative model can be employed to generate synthetic input examples (e.g., natural language queries) corresponding to a given expected output (e.g., a security language query) in order to form the shots. However, this approach may result in shots that are not representative of the actual input received at inference time. For example, synthetic natural language queries generated in this manner are for example are longer and more detailed than typical real user natural language queries. Accordingly, such shots may not act as useful guides to the generative model in generating the output. Examples of the disclosure therefore provide techniques for generating shots, which may more closely correspond to input instructions received at inference time.

In overview, examples of the disclosure generate inputs (e.g., prompts) that cause a generative model to generate synthetic example input instructions corresponding to an example generative model output. “Synthetic” in this context refers to machine generated, as opposed to being written or otherwise generated by a user or expert. The inputs cause the generative model to generate the synthetic example input instructions in correspondence with different tiers, which may represent differing levels of precision, complexity or sophistication. In some examples, the tiers correspond to humans of different levels of skill or knowledge, and may be referred to herein as personas. The personas may for example correspond to security analysts of different skillsets, medical professionals of different skills, or other such domain experts. This has the effect of generating more realistic example input instructions, which more closely correspond to real input instructions (e.g., queries asked by users). In some examples, the prompts take a chain-of-thought form, causing the generative model to generate increasingly complex synthetic example input instructions in a series of steps, with each step for example corresponding to a successively more complex tier. The example input instructions are then combined with the example generative model output to form a shot, stored in a shot database.

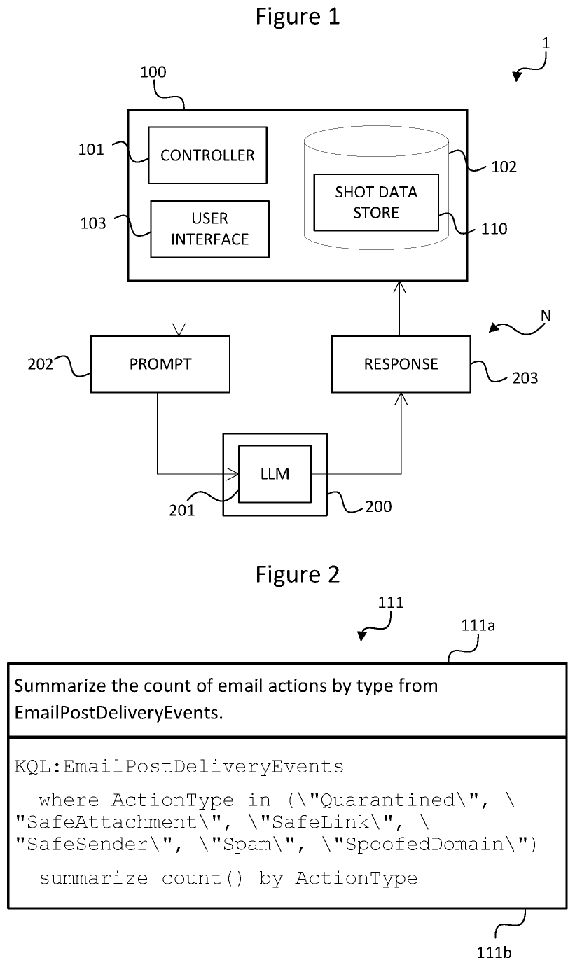

Turning now to FIGS. 1 to 8, a first example of the disclosure will be discussed, in which the disclosed techniques are applied to query language generation from natural language. FIG. 1 illustrates an environment 1 in which examples of the disclosure may operate.

The environment 1 includes a large language model (LLM) 201, which is an example of a generative model. The LLM 201 is a trained language model, based on the transformer deep learning network. The LLM 201 is trained on a very large corpus (e.g., in the order of billions of tokens), and can generate text or data in response to receipt of an input in the form of a prompt.

An example of a suitable LLM 201 is the Open AI General Pretrained Transformer (GPT) model, for example GPT-3, GPT-3.5 turbo or GPT-4. However, a variety of LLMs 201 may be employed in the alternative.

The LLM 201 operates in a suitable computer system 200. For example, the LLM 201 is stored in a suitable data centre, and/or as part of a cloud computing environment or other distributed environment. The LLM 201 is accessible via suitable APIs (application programming interfaces), for example over a network N. The network may comprise any suitable links, including wired and wireless links and local and wide area networks.

The environment 1 also includes a computer system 100 for generating a shot data store 110. The computer system 100 is configured to interact with the LLM 201. The system 100 is configured to generate suitable prompts 202 and submit them to the LLM 201 over the network. In addition, the system 100 is configured to receive a response 203 (also referred to as a “completion”) from the LLM 201.

The computer system 100 also includes a controller 101 and a storage 102. The controller 101 includes a processor or other compute unit configured to execute instructions stored in the storage 102, to carry out the operations and processes discussed in further detail herein. The storage 102 may include volatile and non-volatile memory. The system 100 may also further include a suitable user interface 103.

The storage 102 stores a shot data store 110. The shot data store 110 is configured to store a plurality of shots 111. The shots 111 generally take the form of a pair comprising an example input to the LLM 201, and a corresponding example output from the LLM 201. In this context, the shots 111 are for use in generating KQL from natural language. Accordingly, each shot in the shot datastore comprises corresponding natural language queries and KQL queries, hereinafter referred to as an NL-KQL pair. The respective NL and KQL may be stored as strings of text. The natural language query and KQL query may correspond in the sense that the KQL query is a valid response to the natural language query. The shot data store 111 may take the form of any suitable data storage structure, including but not limited to one of a relational database or a non-relational database (e.g., NoSQL database).

FIG. 2 illustrates an example shot 111, which comprises a natural language query 111a and a corresponding KQL query 111b. In the example, the natural language query 111a reads “Summarize the count of email actions by type from EmailPostDeliveryEvents”. The corresponding KQL 111b is a structured query language query which, when executed by a suitable query engine, would return results corresponding to those asked for in the natural language query 111a.

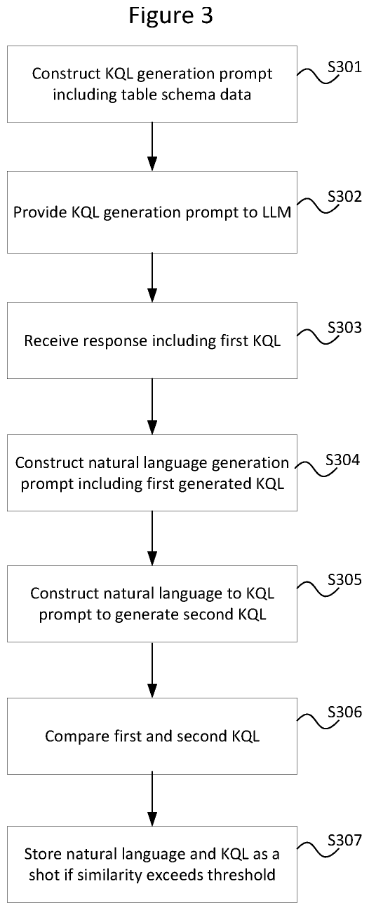

FIG. 3 illustrates a process of generating KQL queries for the shots data store 110, which may be carried out by system 100.

In a first step S301, a KQL generation prompt is constructed. The KQL generation prompt is for generating synthetic KQL from input database schema data. In other words, the prompt includes instructions that cause the LLM 201 to generate KQL queries that are capable of execution in a database having the supplied schema. In this context, instructions refer to natural language instructions (e.g., in English) that can be received as input by the LLM 201 and processed thereby, rather than machine-readable instructions. The database schema data may be extracted from a database associated with a security product such as Microsoft Defender or Sentinel.

As well as including the database schema data, the KQL generation prompt includes template text comprising instructions, which is for example stored in storage 102. The KQL generation prompt may also include at least one, but preferably several (e.g., up to 6), examples of pairs of table schema data and associated KQL, forming shots for the KQL generation prompt.

The process of constructing (or generating) the prompt may include retrieving one or more strings from the storage 102, such as the template text, the shots and/or the further elements such as headers or footers. It may also comprise generating one or more strings, for example by converting data extracted from the storage 102 (e.g., the table schema data stored in structured form) into strings. The resulting strings can then be concatenated or otherwise combined to form the prompt. For example, each string may be loaded into memory, and combined to form a larger string comprising the prompt. The prompt is then stored in memory (e.g., in volatile memory) before being transmitted to the LLM 201, e.g., via an API call.

The template text includes a specific instruction for carrying out the task (e.g., “Write a KQL query that can be executed in the following database schema:”). In addition, the template text can include a wide variety of contextual information that assists the LLM 201 in providing an appropriate response. This may include one or more of the following: a problem statement explaining cybersecurity and Kusto; an explanation of a natural language request; general instructions of tables, variables and columns; statements explaining sources, joins and operators; and information regarding the expected complexity of the KQL.

In step S302, the prompt is provided to the LLM 201, and a response is received in step S303. The received prompt includes at least one synthetic KQL query, but preferably includes several KQL queries. The response is processed to extract the KQL therefrom, for example using suitable regular expressions.

These steps may be repeated until a desired number of synthetic KQL queries have been generated. In examples, the LLM 201 is non-deterministic. Consequently, repeatedly providing the same prompt to the LLM 201 results in different KQL being received in response. For example, the LLM 201 may have one or more hyperparameters that control the randomness of the output. This may include a “temperature” parameter, which controls the randomness (also referred to as the creativity) of the output of the LLM 201. This may also include a top-p sampling parameter, which is used in selecting the top-p most probable tokens whose collective probability mass is greater than or equal to a threshold p. Setting these parameters, (or other such hyperparameters) appropriately allows the LLM 201 to provide different results in response to the same prompt.

Alternatively or additionally, in each repeat, some aspect of the prompt may be varied, so that each repeat generates different synthetic KQL queries. For example, different subsets of the table schema data may be included in different prompts, or the number and selection of shots may vary.

For example, 30,000 to 50,000 KQL queries may be generated by this technique. By employing a relatively fast LLM 201 (e.g., GPT 3.5 turbo), this number of KQL queries can be generated in a reasonable time frame (e.g., 3 days).

The subsequent steps S304-S307 of FIG. 3 represent a technique for validating the generated KQL queries. In outline, the technique is a “round-trip” technique, in which the generated KQL is used to generate a corresponding natural language query, and then the natural language query is used to generate a second KQL query. The originally generated (or “first”) KQL query is compared to the second KQL query. If the two queries are sufficiently similar, the originally generated KQL query and the natural language form a valid NL-KQL pair.

In more detail, in step S304, a natural language generation prompt is constructed. The natural language generation prompt instructs the LLM to generate a natural language query that corresponds to a synthetic KQL query. The prompt includes template text similar to that discussed above, one or more NL-KQL pairs as shots and the synthetic KQL. The NL-KQL pairs included in these may be manually generated. The prompt is then input to the LLM 201, and a response including the natural language query is received. The response is parsed to extract the natural language query.

In step S305, an NL to KOL generation prompt is constructed. The NL to KQL generation prompt instructs the LLM to generate a KQL from the natural language query generated in step S304. The prompt includes template text similar to that discussed above, one or more NL-KQL pairs as shots and the natural language query. The NL-KQL pairs included in these may be manually generated. The prompt is then input to the LLM 201, and a response including a second KQL query is received. The response is parsed to extract the second KQL query.

In step S306, the second KQL query is compared to the synthetic KQL query generated in step S303. A similarity metric is used to compare the two KQL queries. If the similarity metric is greater than a predetermined threshold, an NL-KQL pair comprising the KQL generated in step S303 and the natural language generated in step S304 are stored in step S307. The NL-KQL queries may be stored in a suitable storage structure (e.g., a database) in storage 102. Otherwise, the NL-KQL pair is discarded.

In one example, the Jaccard index is employed to measure the similarity between the two KQL queries. The Jaccard index is calculated by dividing the intersection of two sets by the union of two sets. In this case, each query is treated as a set of words. The predetermined threshold may for example be 0.75.

It will be understood that the any suitable measure of similarity may be employed to compare the two queries. Other examples include edit distances, and approaches based on embedding the queries into an embedding space (i.e. a multidimensional vector space) and measuring the similarity of the vectors using metrics such as the cosine distance or Manhattan distance.

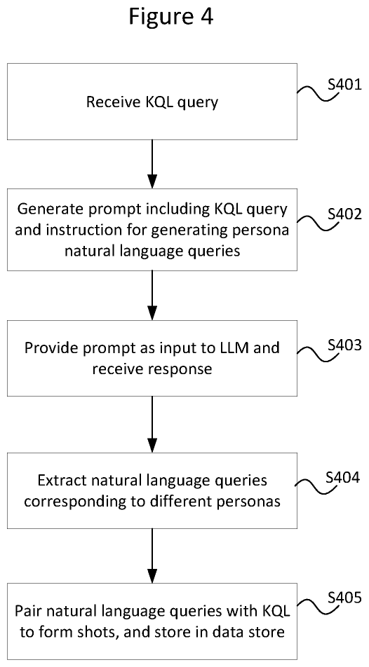

FIG. 4 illustrates another process of generating natural language from KQL queries, which may be carried out by the system 100. The process of FIG. 4 may take the output of the process of FIG. 3 as input. That is to say, the NL-KQL pairs generated and validated according to the round-trip technique of FIG. 3 may form the basis of the processing carried out in FIG. 4. However, the process of FIG. 4 may also be carried out on the basis of synthetic NL-KQL pairs generated by other techniques, or on manually generated NL-KQL pairs.

In step S401, a KQL query is received. The KQL query may be one half of an NL-KQL pair discussed above.

In step S402, a prompt is generated. The prompt is for generating a plurality of natural language queries corresponding to the KQL query, and accordingly includes instructions which, when executed by the LLM 201, cause the LLM 201 to generate the plurality of natural language queries. Each natural language query corresponds to a different persona, and thus the prompt may be referred to herein as the persona generation prompt.

In other words, each of the generated natural language queries is intended to reflect the point of view of a different type or category of user, who may have written the natural language.

Particularly, it has been found that the type of natural language employed by users in the context of KQL generation varies according to the experience of the user in security hunting, or the role in which they are employed. For example, security analysts employed in a Security Operations Center (SOC), typically have a hierarchy of roles that may be generally as follows:

Tier 1 security analysts (also referred to as junior analysts) are usually the first responders in case of any security incident. They monitor networks for suspicious activities, handle basic security alerts and help to address low-level issues efficiently. For example, they may respond to alerts about failed login attempts or perform initial malware scans.

Tier 2 security analysts (also referred to as intermediate analysts) deal with slightly more complex issues escalated from Tier 1. They may conduct in-depth analysis on the anomaly in network traffic or unusual server activities. They also correlate information for incident response, perform forensic analysis, and may take part in mitigation and recovery efforts from more significant security incidents.

Tier 3 security analysts (also referred to as advanced analysts) are the most experienced and knowledgeable group in the SOC. They handle the most complex security scenarios where advanced threat hunting skills are often required. For instance, they could be involved in investigating a zero-day vulnerability or responding to a major data breach. They typically develop strategies for incident prevention, response, and recovery, as well as implement long-term defense mechanisms to enhance the overall security posture of an organization. They may also mentor the lower-tier analysts, sharing their expertise and knowledge.

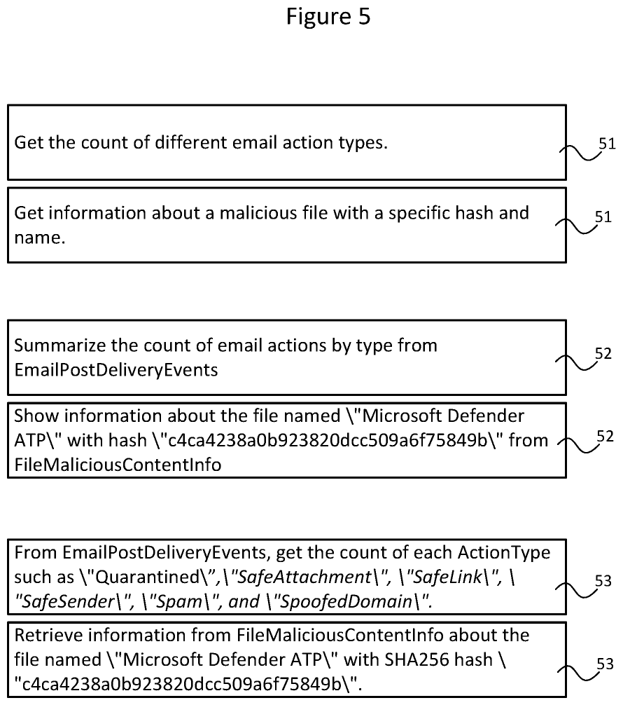

FIG. 5 illustrates example natural language queries associated with each of these personas. In more detail, there are shown queries 51 that are examples of junior analyst queries. These are typically short and direct. Queries 52 are examples of intermediate analyst queries, which include more detail, and are more likely to include specific table names or column names known to the analyst. Queries 53 are examples of advanced analyst queries, which make regular use of specific table and column names and are more likely to have a more complex structure.

It will be appreciated that these tiered roles are not hard boundaries between the skillsets and roles of users, but instead serve as a helpful approximation of the language likely to be used by security analysts. In other examples, fewer than three tiers or more than three tiers may be identified or used. In other examples, the personas need not follow a tiered hierarchy, but may instead represent related roles or groups of users with different responsibilities. In other examples, the personas need not relate to particular skillsets but instead more broadly relate to different points of view or considerations that would be borne in mind by the hypothetical author of the generated natural language.

Returning to step S402 of FIG. 4, the prompt may include instructions that cause the LLM 201 to generate the plurality of natural language queries according to a Chain-of-Thought (CoT) prompting technique. CoT prompting is a technique in which the LLM 201 is guided to generate a response by undertaking a plurality of intermediate reasoning steps, to some extent mimicking the reasoning that would be carried out by a human. CoT prompting is discussed in detail in Wei, Jason, et al. “Chain-of-thought prompting elicits reasoning in large language models.” Advances in Neural Information Processing Systems 35 (2022): 24824-24837.

For example, the progression of a natural language query associated with a tier 1 analyst, tier 2 analyst and then tier 3 analyst can be framed as a series of related steps.

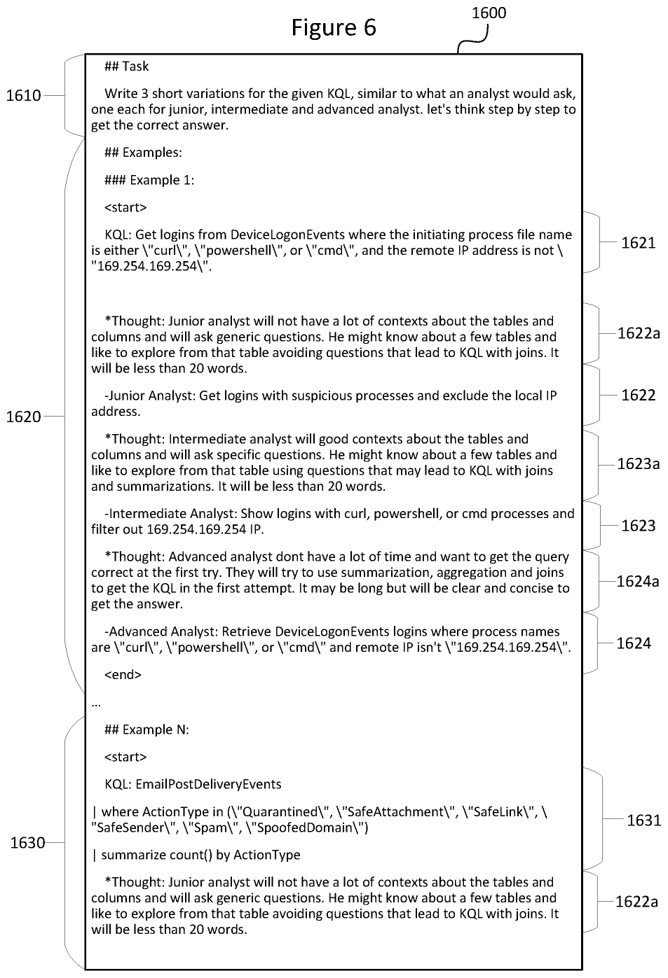

FIG. 6 illustrates an excerpt of the persona generation prompt 1600. The prompt includes instructions 1610 that specify that the LLM 201 should generate three variations of the natural language from the KOL, respectively corresponding to the roles of tier 1 to tier 3 analysts. The prompt 1600 also includes an example 1620 (i.e. a shot), which shows an input KQL query 1621, and examples of natural language respectively associated with a junior analyst 1622, intermediate analyst 1623 and advanced analyst 1624. Preceding each natural language example 1622-1624 is a respective thought text 1622a-1624a, which provides context to the LLM 201 as to the role of the analyst and the likely form of the natural language. Each example 1620 may be labelled with tags representing its start point and end point. Although one example 1620 is illustrated, in reality a plurality (e.g., 2 or 3) examples of this form may be included in the prompt 1600.

In some examples, the examples 1620 are manually generated. However, in other cases examples 1620 may be synthetically generated. For example, an LLM is used to generate the CoT examples. Particularly, it has been found the most recent generation of LLMs such as GPT-4 are capable of generating the CoT examples. The examples 1620 are generated in advance and stored, for example based on hand-crafted prompts.

The prompt 1600 finishes with an incomplete example 1630, which includes the received KQL query 1631 and the first thought text 1622a.

The prompt 1600 may also include template text (not shown), similar to that discussed above. In some further examples, the prompt 1600 may also include the natural language that forms the shot with the input KQL query. For example, in some cases the generic natural language that is not persona specific may also be used in guiding the LLM 201 to generate the persona-specific natural language.

In step S403, the prompt 1600 is provided as input to the LLM 201, and a response is received. The response completes the incomplete example 1630, and thus includes natural language queries corresponding to the respective personas.

In step S404, the response is parsed to extract the natural language queries corresponding to the respective personas. As discussed above in relation to the parsing of other responses from the LLM 201, this may include applying suitable regular expressions to extract the natural language queries.

In step S405, each natural language query is paired with the KOL and stored as a shot in the shot data store 110.

Accordingly, the process of FIG. 4 populates the shot data store 110 with shots that include natural language that more realistically corresponds to the input queries provided by users.

In some examples, the shot data store 110 comprises only shots generated according to the above techniques. However, it may also be the case that an existing data store 110 of shots is augmented by the inclusion of shots generated according to the above techniques.

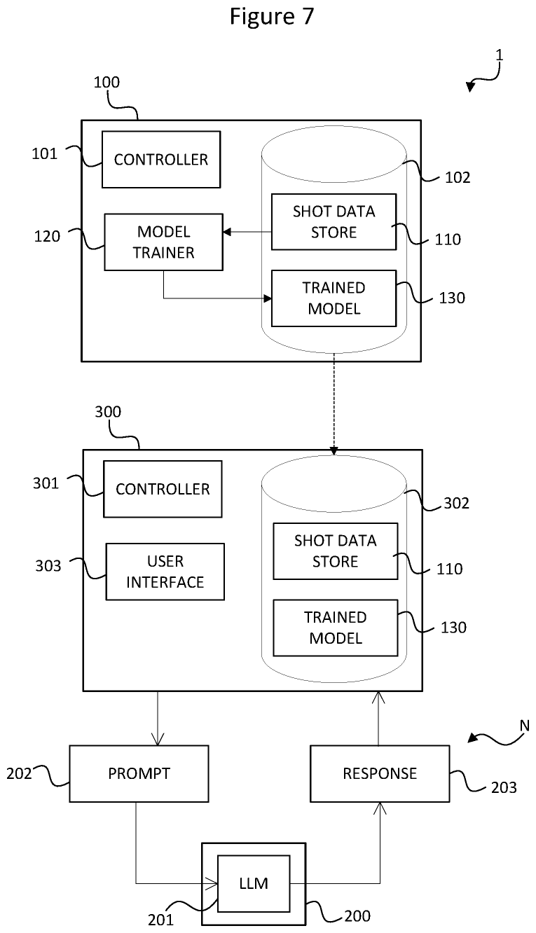

FIG. 7 illustrates an example of how the shots in the shot data store 110 is employed in the generation of KQL from natural language input queries.

In the example of FIG. 7, the system 100 further includes model trainer 120. The model trainer 120 is configured to train an embedding model 130, using the natural language of the shots stored in shot data store 110. The embedding model 130 is configured to generate a representation (an “embedding”) of natural language in multi-dimensional vector space.

For example, the model trainer 120 may fine-tune another LLM (i.e. not LLM 201) to act as the embedding model 130. The model 130 may be a BERT-based model (see Devlin, Jacob; Chang, Ming-Wei; Lee, Kenton; Toutanova, Kristina (11 Oct. 2018). “BERT: Pre-training of Deep Transformers for Language Understanding”. Bidirectional arXiv: 1810.04805v2). An example BERT-based model is DistilBERT, which is discussed in Sanh, Victor, et al. “DistilBERT, a distilled version of BERT: smaller, faster, cheaper and lighter.” arXiv preprint arXiv: 1910.01108 (2019). However, in other examples different embedding models may be trained, either from scratch or by fine-tuning a pretrained model.

The trained model 130 is then capable at inference time of generating an embedding for an unseen input natural language query.

The system 100 further generates embeddings for the natural language query of each NL-KQL pair. This may also be stored in the data store 110, for example as another column in a database table.

As further illustrated in FIG. 7, the environment 1 may further include system 300. The system 300 includes controller 301 and storage 302 which correspond generally in function to the same components of system 100. The storage 302 stores the trained model 130 and shots data store 110. The system 300 is further configured to receive user input via a user interface 303 in the form of a natural language user query.

The computer system 300 is a security system. That is to say the computer system 300 is configured to prevent or detect cybersecurity threats. The computer system 200 may for example comprise suitable cybersecurity software, such as Microsoft® Defender® or Sentinel®. As such, the storage 302 may store application data in the form of one or more databases associated with the cybersecurity software. The databases may store information generated by the cybersecurity software. For example, the database may include tables storing cybersecurity incidents, details of users and permissions, records of accesses of certain resources of the system etc. Although as described FIG. 7 shows a security system 300, it may equally be a system that accesses remotely hosted (e.g., cloud hosted) security software.

In use, the system 300 receives the user query and uses the trained model 130 to generate an embedding of the user query. The embedding of the user query is then compared with embeddings stored in the data store 110, to identify one or more shots that are similar to the user query. For example, the cosine distance or Manhattan distance or any other similar technique for estimating similarity may be employed. In some examples, the top k (e.g., k=3 or k=5) most similar shots are selected. In other examples, shots having a similarity above a certain threshold are selected.

The selected shots are then included in a prompt for generating KQL from the natural language input user query. The prompt is input to the LLM 201, and a response is received including corresponding KQL. The KQL is extracted from the response, and then may be provided to the user.

Options for providing the KQL to the user include displaying the KQL in a dialog box or other suitable user interface element, or automatically pasting the KQL into a suitable query interface accessible to the user. The query then may be executed in relation to the databases stored in storage 302 or databases stored elsewhere, to retrieve data therefrom. In some examples, the query may be executed automatically by system 300 upon extraction from the response.

Although in FIG. 7 the system 300 is shown to locally-store the trained model 130 and shots data store 110, in other examples the model 130 and/or data store 110 may be stored remotely from system 300 and accessible over a network.

Furthermore, the example discussed with respect to FIG. 7 is merely one way in which shots stored in the data store 110 may be selected. For example, frequency-based metrics such as tf-idf may be employed to compare the input natural language query to the shots in the data store 110. In other examples, machine learning models may be trained to select an appropriate shot, e.g., by ranking the shots (or a subset thereof).

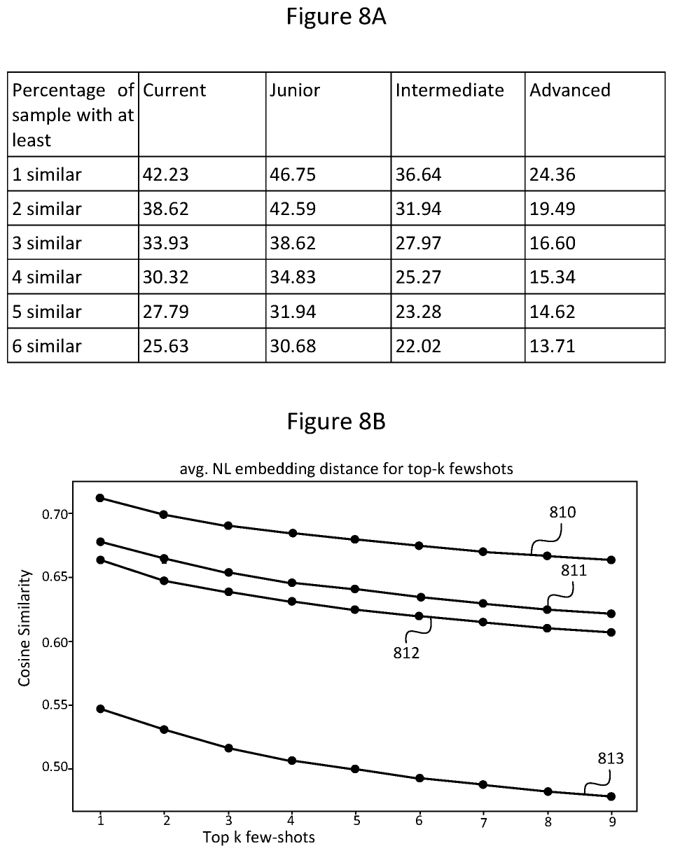

FIGS. 8A and 8B illustrate an evaluation of the performance of the techniques herein.

The table of FIG. 8A illustrates, for a set of held-out input user queries, the percentage of the input queries that have at least 1-6 similar shots in the database 110. The input queries are representative of actual language used by junior analysts. In this example, a shot is deemed similar if it has a cosine distance from the input query under a predetermined threshold. In this case, the threshold was 0.80. The “current” column represents an existing few shot data store without the addition of tiered data, and the “junior”, “intermediate” and “advanced” columns represent those subsets of the data store. As can be seen, the input queries are most similar to the junior analyst shots in the data store.

FIG. 8B relates to the same experimental set up as FIG. 8A, and illustrates the average cosine distance between the input queries and the top-k shots in the few shot database. Line 810 corresponds to the junior analysts, 811 to the current data set, 812 to the intermediate analysts and 813 to the advanced analysts. The input queries are again most similar to the junior analyst shots.

In the examples of FIG. 1-8, reference is made to KOL as an example security query language. KQL is merely an example of such a security query language, and the techniques disclosed herein can be applied to other query languages such as those used in Splunk and Google security products.

Furthermore, the examples discussed herein apply equally to the generation of queries in other query languages. These may include query languages such as structured query language (SQL), GraphQL, BigQuery, Cypher, SPARQL, XQuery and the like.

Beyond query languages, the examples herein may apply more generally to the generation of other types of structured code. That is to say, the desired output from the LLM need not be a query language query, but can instead be a suitable piece of code in any computer language. This may be for example a snippet of code, such as a function or method, but could also be a longer segment of code or a complete program. This may include code in any suitable programming language (e.g., Python, C, Java, Haskell etc), as well as code in markup languages such as HTML (Hypertext Markup Language), XML (Extensible Markup Language), LaTeX etc.

Furthermore, the disclosure extends to a wide range of other domains beyond security hunting. A selection of other domains are discussed below.

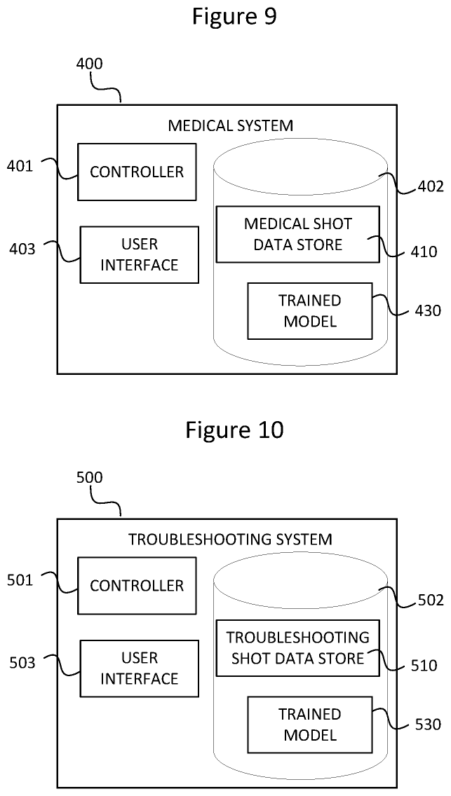

FIG. 9 illustrates a medical screening system 400. The medical screening system includes a controller 401, storage 402 and user interface 403. The medical screening system 400 is configured similarly to system 300 discussed above, and thus only the differences will be discussed in detail. Elements with reference numerals prefixed “4” in FIG. 9 may have the corresponding function to features bearing the same reference numeral prefixed “1” or “3” in the examples above.

The medical screening system 400 is configured to receive input instructions in the form of patient or other medical data related natural language questions. In response to such input queries, the system 400 provides a response that includes a query language query for execution in a medical database storing the patient data or other medical data.

The system 400 includes a medical shot data store 410, which includes shots that are in the form of pairs comprising an example user input query in relation to medical data and a corresponding query language query. The shots in the data store 410 are generated using the techniques discussed herein in relation to FIGS. 1 to 8, but adapted for the domain of medical queries. Accordingly, the tiers of users in this example may be e.g., medical professionals of different levels of skill or with different experience and background knowledge.

It will be understood that this teaching may be applied to a wide range of domains. For example, the tiers may represent different humans of different levels of skill or point of view in a wide range of fields, including customer service representatives, engineers or technicians, programmers, and so on.

In the examples above, an LLM is used at inference time to generate a computer language output, such as a query language query or code snippet. However, in further examples, the output of the LLM may be natural language.

FIG. 10 illustrates a machine troubleshooting system 500. The system 500 includes a controller 501, storage 502 and user interface 503. The troubleshooting system 500 is configured similarly to system 400 discussed above, and thus only the differences will be discussed in detail. Elements with reference numerals prefixed “5” in FIG. 10 may have the corresponding function to features bearing the same reference numeral prefixed “4” in FIG. 9.

The machine troubleshooting system 500 is configured to receive input instructions in the form of natural language troubleshooting requests in relation to a defect or issue in a machine or system. Example machines or system include production lines or manufacturing equipment, vehicles, power systems, computer networks and so on. In response to such input queries, the system 500 provides a natural language response including guidance for resolving the issue. The guidance may include a series of steps to be carried out by the user to resolve the problem. In other words, the query, when executed, retrieves data from the database to answer the troubleshooting request.

The system 500 includes a troubleshooting shot data store 510, which includes shots that are in the form of pairs comprising an example user input query for troubleshooting the machine or system and a corresponding guidance. The shots in the data store 510 are generated using the techniques discussed herein in relation to FIGS. 1 to 8, but adapted for the domain of machine troubleshooting. Accordingly, the tiers of users in this example may be e.g., maintenance technicians of different levels of skill or with different experience.

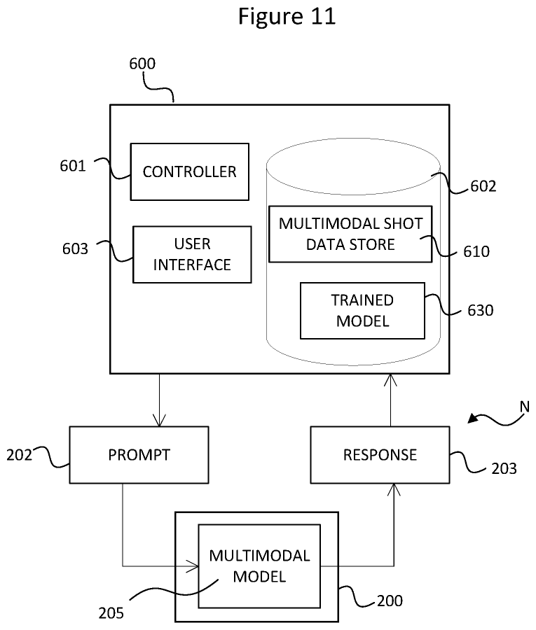

FIG. 11 illustrates a further example system 600. The system includes a controller 601, storage 602 and user interface 603. The system 600 is configured similarly to system 500 discussed above, and thus only the differences will be discussed in detail. Elements with reference numerals prefixed “6” in FIG. 11 may have the corresponding function to features bearing the same reference numeral prefixed “5” in FIG. 10.

In the example of FIG. 11, the system 600 is in communication with a generative model in the form of a multimodal model 205. The multimodal model 205 is configured to receive an input in the form of text-based prompt 202 as discussed above. However, the response 203 may include output in a modality other than text. For example, the output may be an image, a sound, a control signal or command for a machine or vehicle or other system. In some examples, the output forms an instruction for a downstream system, in a similar way to which the query language queries form input to a downstream database system. For example, the image or sound may comprise an instruction for a downstream system.

The system 600 includes a multimodal shot data store 610. Each shot in the data store 610 comprises an example natural language input instruction to the multimodal model and a corresponding example output in the modality other than text. The shots in the data store 610 are generated using the techniques discussed herein in relation to FIGS. 1 to 8, but adapted for the multimodal model 205. For example, the prompts may be adapted to generate synthetic natural language in tiers that corresponds to an image, sound, or one of the other outputs discussed above.

Whilst the examples described herein relate to user input queries (i.e. input instructions) that are in the form of natural language (i.e. utterances), the user input queries are not limited to this form. In some examples, the input queries can include structured data. For example, the input queries may include graphs illustrating relations between entities, or tabular data.

More widely, the input instruction to the generative model may also be in a variety of different modalities. For example, the generative model may be configured to receive one of an image, a sound, a video, code (e.g., query language or other computer language code), structured data, sensor data or an analog signal. In such an example, the tiers may reflect a level of complexity or precision in the input data. For example, the tiers may represent precision levels of machine sensors, levels of machine data (e.g., low-level alert data versus more complex-level incident data), levels of image data (e.g., coarse image data versus high resolution image data, simple icon versus complex drawing), a combination of tiered information, or any other tiered context. In such examples, the generative model need not receive a textual prompt, but may instead receive any of the above described inputs in a suitable encapsulation (e.g., a container format, a file, a message over a network etc).

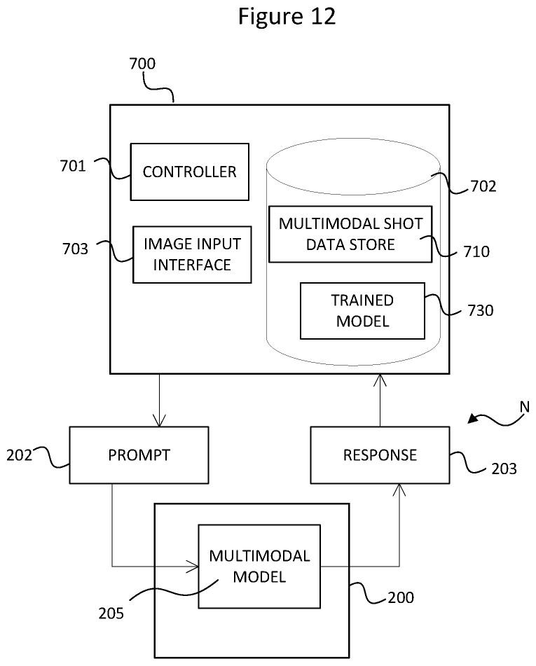

FIG. 12 illustrates an example of a system 700 configured to receive an image as input. The system includes a controller 701 and storage 702. The system 700 is configured similarly to system 600 discussed above, and thus only the differences will be discussed in detail. Elements with reference numerals prefixed “7” in FIG. 12 may have the corresponding function to features bearing the same reference numeral prefixed “6” in FIG. 11.

The system 700 comprises an image input interface 703, configured to receive an image. For example, the input interface 703 may be a camera interface connectable to a camera or other suitable capture device, or a network interface configured to receive an image over a network. The received images, which form the generative model input, may be in one of a plurality of different detail levels. The system 700 is in communication with a multimodal model 205, which is configured to generate an output. The output may for example be an analysis of the image (e.g., a textual description), a suitable control signal for a downstream system, code (e.g., a query language query or code snippet) or any other output discussed herein.

The system includes a data store 710 storing shots, each shot comprising an example input image and a corresponding output. The shots in the data store 610 are generated using the techniques discussed herein in relation to FIGS. 1 to 8, but adapted for the multimodal model 205. For example, the prompts may be adapted to generate example images in tiers that correspond to different levels of image detail, based on an example output of the model.

In the discussion herein, the generative model that generates the shots need not be the same generative model that is used at inference time. Furthermore, shots may be broadly considered to refer to training examples for a machine learning model, and the examples are not limited to few shot learning with generative models. Instead, the examples extend to the fine-tuning of models and the training of models from scratch using the shots generated according to the present techniques. In examples where the input instruction is in a modality other than text, appropriate means of selecting example shots from the database for inclusion in the input to the model may be provided. For example, in examples relating to images, suitable image similarity metrics may be employed.

Advantageously, the techniques herein provide a means of generating shots that more closely mirror the input instructions provided to a model at inference time. For example, the techniques herein provide a means of generating shots that more closely mirror user input natural language. Accordingly, more representative shots can be included in prompts for generating output such as KQL from natural language.

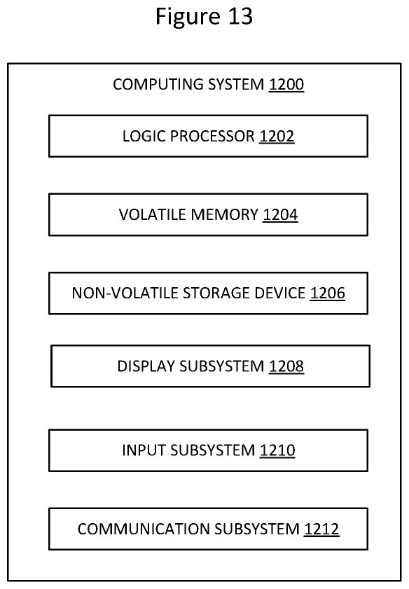

FIG. 13 schematically shows a non-limiting example of a computing system 1200 that can enact one or more of the methods and processes described above. Computing system 1200 is shown in simplified form. Computing system 1200 may embody any of the computer devices 100, 200, 300, 400, 500, 600 or 700 described above, or any other computer device discussed herein. Computing system 1200 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 1200 includes a logic processor 1202, volatile memory 1204, and a non-volatile storage device 1206. Computing system 1200 may optionally include a display subsystem 1208, input subsystem 1210, communication subsystem 1212, and/or other components not shown in FIG. 10.

Logic processor 1202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 1202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1206 includes one or more physical devices configured to hold instructions executable by the logic processors to implement the methods and processes described herein. When such methods and processes are implemented, the state of non-volatile storage device 1206 may be transformed—e.g., to hold different data.

Non-volatile storage device 1206 may include physical devices that are removable and/or built-in. Non-volatile storage device 1206 may include optical memory (e g., CD, DVD, HD-DVD, Blu-Ray Disc, etc), semiconductor memory (e g., ROM, EPROM, EEPROM, FLASH memory, etc.), and/or magnetic memory (e.g., hard-disk drive), or other mass storage device technology. Non-volatile storage device 1206 may include nonvolatile, dynamic, static, read/write, read-only, sequential-access, location-addressable, file-addressable, and/or content-addressable devices. It will be appreciated that non-volatile storage device 1206 is configured to hold instructions even when power is cut to the non-volatile storage device 1206.

Volatile memory 1204 may include physical devices that include random access memory. Volatile memory 1204 is typically utilized by logic processor 1202 to temporarily store information during processing of software instructions. It will be appreciated that volatile memory 1204 typically does not continue to store instructions when power is cut to the volatile memory 1204.

Aspects of logic processor 1202, volatile memory 1204, and non-volatile storage device 1206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1200 typically implemented in software by a processor to perform a particular function using portions of volatile memory, which function involves transformative processing that specially configures the processor to perform the function. Thus, a module, program, or engine may be instantiated via logic processor 1202 executing instructions held by non-volatile storage device 1206, using portions of volatile memory 1204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1208 may be used to present a visual representation of data held by non-volatile storage device 1206. The visual representation may take the form of a graphical user interface (GUI). Because the herein described methods and processes change the data held by the non-volatile storage device, and thus transform the state of the non-volatile storage device, the state of display subsystem 1208 may likewise be transformed to visually represent changes in the underlying data. Display subsystem 1208 may include one or more display devices utilizing virtually any type of technology. Such display devices may be combined with logic processor 1202, volatile memory 1204, and/or non-volatile storage device 1206 in a shared enclosure, or such display devices may be peripheral display devices.

When included, input subsystem 1210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1212 may be configured to communicatively couple various computing devices described herein with each other, and with other devices. Communication subsystem 1212 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1200 to send and/or receive messages to and/or from other devices via a network such as the internet.

Additional example features of the disclosure are set out below.

According to a first aspect of the disclosure, there is provided a computer implemented method, comprising: receiving an example generative model output; generating an input for a generative model, the input comprising: the example generative model output, and instructions which, when processed by the generative model, cause the generative model to generate a first example input instruction according to a first tier and a second example input instruction according to a second tier, the first example input instruction and second example input instruction each corresponding to the example generative model output; providing the input to the generative model; receiving a response from the generative model including the first example input instruction and the second example input instruction; extracting the first example input instruction and second example input instruction from the response; and storing, in a data store, a first shot comprising the first example input instruction and the example generative model output and a second shot comprising the second example input instruction and the example generative model output.

The example generative model output may be a computer language output. The computer language output may be a query language query. The query language query may be a security language query. The computer language output may be code in a programming language or markup language.

The example generative model output may be a natural language output. The natural language output may be troubleshooting guidance. The troubleshooting guidance may be in relation to a system or machine.

The first tier may correspond to a first persona and the second tier may correspond to a second persona. The first persona and second persona may correspond to different hypothetical users, suitably of different skills. The first persona and second persona may be security analysts of different skills. The first persona and second persona may be medical professionals of different skills.

The generative model may be a large language model, LLM. The first example input instruction and second example input instruction may each be natural language queries. The input may comprise a prompt for the LLM.

The instructions may cause the generative model to generate the first example input instruction and second example input instruction as part of a chain-of-thought. The input may comprise a tier generation shot, the tier generation shot comprising a second example generative model output, a third example input instruction corresponding to the first tier and a fourth example input instruction corresponding to the second tier. The third example input instruction and second example input instruction may each correspond to the second example generative model output. The third example input instruction may be preceded by instructions explaining the first tier, and the second example input instruction may be preceded by instructions explaining the second tier.

The method may comprise receiving database schema data; generating a first query language generation prompt, comprising: the database schema data, and instructions which, when processed by the LLM, cause the LLM to generate a first query language query executable in a database having a schema corresponding to the database schema data; providing the first query language generation prompt as input to the LLM; receiving a response from the LLM including a first generated query language query; extracting the first generated query language query from the response; generating a natural language generation prompt, comprising; the first generated query language query; instructions which, when processed by the LLM, cause the LLM to generate a third natural language query corresponding to the first generated query language query; providing the natural language generation prompt as input to the LLM; receiving a response from the LLM including a generated third natural language query; extracting generated third natural language query from the response; generating a second security query language generation prompt, comprising: the generated third natural language query, and instructions which, when processed by the LLM, cause the LLM to generate a second query language query corresponding to the generated third natural language query; providing the second query language generation prompt as input to the LLM; receiving a response from the LLM including a second generated query language query; extracting the second generated query language query from the response; determining a similarity between the first generated query language query and the second generated query language query; in response to the similarity being greater than a predetermined threshold, storing the first generated language query and the generated third natural language query; and in response to the similarity being less than or equal to the predetermined threshold, discarding the first generated language query and the generated third natural language query.

The method may comprise receiving an input instruction; selecting a shot from the datastore based on the input instruction; and generating a second input for a second generative model, comprising: the input instruction; the selected shot; and instructions which, when processed by the second generative model, cause the second generative model to generate an output corresponding to the input instruction. The method may comprise providing the providing the second input to the second generative model, receiving a response comprising the output corresponding to the input instruction. The method may comprise providing the output to a downstream system. The generative model and second generative model may be the same.

Selecting the shot may comprise: determining a similarity score between the shot and the input instruction, and in response to the similarity score exceeding a predetermined threshold, selecting the shot.

The method may comprise training a model based on the data store including the first and second shots. The model may be a model for use in selecting the shot based on the input instruction. The model may be an embedding model. The embedding model may be configured to generate a vector representation of the input instruction. The method may comprise generating, using the embedding model, a first embedding for the shot; generating, using the embedding model, a second embedding for the input instruction; and determining the similarity score based on the first embedding and second embedding.

The generative model may be a multimodal model, suitably configured to receive input in a first modality and provide output in a second modality.

The first example input instruction and second example input instruction may each be one of an image, sound, video, code, analog signal, structured data, or sensor data. The first tier and second tier correspond to different levels of complexity.

The optional features defined above in relation to the first aspect may be combined in any combination. Accordingly, each sentence in the optional features defined above can be read as if it is a dependent claim referring to the features of any preceding sentence.

According to a second aspect of the disclosure there is provided a computer-implemented method, comprising: receiving a security language query computer language input; generating a prompt for a large language model, LLM, the prompt comprising: the security language query computer language input, and instructions which, when processed by the LLM, cause the LLM to generate a first natural language query according to a first persona and a second natural language query according to a second persona, the first and second natural language queries each corresponding to the security language query computer language input, providing the prompt as input to the LLM; receiving a response from the LLM including the first natural language query and the second natural language query; extracting the first and second natural language queries from the response; and storing, in a data store, a first shot comprising the first natural language query and the security language query computer language input and a second shot comprising the second natural language query and the computer language input.

Further optional features of the second aspect are defined above in relation to the first aspect and may be combined in any combination.

According to another aspect of the disclosure there is provided a computer system comprising a processor and a memory, the memory storing instructions, which when executed by the processor, cause the system to carry out any of the methods defined herein.

According to another aspect of the disclosure there is provided a tangible non-transient computer-readable storage medium having recorded thereon instructions which, when executed by a computer device, cause the computer device to perform any of the methods set forth herein.

According to another aspect of the disclosure there is provided a computer program product comprising instructions which, when executed by the testing apparatus of the first aspect, cause the computer device to perform any of the methods set forth herein.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A computer-implemented method, comprising:
receiving an example generative model output;
generating an input for a generative model, the input comprising:
the example generative model output, and
instructions which, when processed by the generative model, cause the generative model to generate a first example input instruction according to a first tier and a second example input instruction according to a second tier, the first example input instruction and second example input instruction each corresponding to the example generative model output,
providing the input to the generative model;
receiving a response from the generative model including the first example input instruction and the second example input instruction;
extracting the first example input instruction and second example input instruction from the response; and
storing, in a data store, a first shot comprising the first example input instruction and the example generative model output, and a second shot comprising the second example input instruction and the example generative model output.

2. The computer-implemented method of claim 1, wherein the example generative model output is a computer language output.

3. The computer-implemented method of claim 2, wherein the computer language output is a query language query.

4. The computer-implemented method of claim 1, wherein the example generative model output is a natural language output.

5. The computer-implemented method of claim 1, wherein the first tier corresponds to a first persona and the second tier corresponds to a second persona,
wherein the first persona and second persona correspond to different hypothetical users of different skills.

6. The computer-implemented method of claim 1, wherein the instructions cause the generative model to generate the first example input instruction and second example input instruction as part of a chain-of-thought.

7. The computer-implemented method of claim 6, wherein the input for the generative model comprises a tier generation shot, the tier generation shot comprising a second example generative model output, a third example input instruction corresponding to the first tier and a fourth example input instruction corresponding to the second tier,
wherein the third example input instruction and second example input instruction each correspond to the fourth example generative model output.

8. The computer-implemented method of claim 1, comprising:
receiving an input instruction;
selecting a shot from the data store based on the input instruction;
generating a second input for a second generative model, comprising:
the input instruction;
the selected shot; and
instructions which, when processed by the second generative model, cause the second generative model to generate an output corresponding to the input instruction;
providing the second input to the second generative model,
receiving a response comprising the output corresponding to the input instruction.

9. The computer-implemented method of claim 8, wherein selecting the shot comprises:
determining a similarity score between the shot and the input instruction, and in response to the similarity score exceeding a predetermined threshold, selecting the shot.

10. The computer-implemented method of claim 1, comprising:
training a model based on the data store, the model for use in selecting a shot from the data store based on a received input instruction.

11. The computer-implemented method of claim 1, wherein the first example input instruction and second example input instruction each are one of an image, sound, video, code, analog signal, structured data, or sensor data, and the first tier and second tier correspond to different levels of complexity.

12. A system comprising a processor and a memory, the memory storing computer-readable instructions, which when executed by the processor, cause the system to perform operations comprising:
receiving an example generative model output;
generating an input for a generative model, the input comprising:
the example generative model output, and
instructions which, when processed by the generative model, cause the generative model to generate a first example input instruction according to a first tier and a second example input instruction according to a second tier, the first example input instruction and second example input instruction each corresponding to the example generative model output,
providing the input to the generative model;
receiving a response from the generative model including the first example input instruction and the second example input instruction;
extracting the first example input instruction and second example input instruction from the response; and
storing, in a data store, a first shot comprising the first example input instruction and the example generative model output, and a second shot comprising the second example input instruction and the example generative model output.

13. The system of claim 12, wherein the example generative model output is a computer language output.

14. The system of claim 13, wherein the computer language output is a query language query.

15. The system of claim 12, wherein the example generative model output is a natural language output.

16. The system of claim 12, wherein the first tier corresponds to a first persona and the second tier corresponds to a second persona,
wherein the first persona and second persona correspond to different hypothetical users of different skills.

17. The system of claim 12, wherein the first example input instruction and second example input instruction each are one of an image, sound, video, code, analog signal, structured data, or sensor data, and the first tier and second tier correspond to different levels of complexity.

18. A non-transitory computer-readable medium storing instructions, which when executed by a processor, cause the processor to:
receive an example generative model output;
generate an input for a generative model, the input comprising:
the example generative model output, and
instructions which, when processed by the generative model, cause the generative model to generate a first example input instruction according to a first tier and a second example input instruction according to a second tier, the first example input instruction and second example input instruction each corresponding to the example generative model output,
provide the input to the generative model;
receive a response from the generative model including the first example input instruction and the second example input instruction;
extract the first example input instruction and second example input instruction from the response; and
store, in a data store, a first shot comprising the first example input instruction and the example generative model output, and a second shot comprising the second example input instruction and the example generative model output.

19. The non-transitory computer-readable medium of claim 18, wherein the example generative model output is a computer language output.

20. The non-transitory computer-readable medium of claim 18, wherein the first tier corresponds to a first persona and the second tier corresponds to a second persona,
wherein the first persona and second persona correspond to different hypothetical users of different skills.
